(19) United States
(12) Patent Application Publication
(10) Pub. No.: US 2013/0240393 A1
(43) Pub. Date: Sep. 19, 2013

(54) FUNCTIONAL PACKAGING FOR A MEDICAL DEVICE

(71) Applicants: Andreas Bode, Frankfurt am Main (DE); Jörg Bigalke, Frankfurt am Main (DE); Ross Macarthur, Cheshire (GB)

(72) Inventors: Andreas Bode, Frankfurt am Main (DE); Jörg Bigalke, Frankfurt am Main (DE); Ross Macarthur, Cheshire (GB)

(21) Appl. No.: 13/989,880

(22) PCT Filed: Dec. 6, 2011
(86) PCT No.: PCT/EP2011/071883

§ 371 Date: May 28, 2013

(30) Foreign Application Priority Data
Dec. 6, 2010 (EP) 10193750.6

(51) Int. Cl. A61J 1/00

(52) U.S. Cl. CPC A61J 1/00
USPC 206/364; 206/363

(57) ABSTRACT

The present invention relates to a packaging for a medical device comprising a casing adapted to at least partially receive and/or to accommodate the medical device featuring at least one user-driven function, wherein the casing comprises at least one functional element adapted to imitate the at least one function of the medical device.

### CROSS REFERENCE TO RELATED APPLICATIONS

The present application is a U.S. National Phase Application pursuant to 35 U.S.C. §371 of International Application No. PCT/EP2011/071883 filed Dec. 6, 2011, which claims priority to European Patent Application No. 10193750.6 filed Dec. 6, 2010. The entire disclosure contents of these applications are herewith incorporated by reference into the present application.

### BACKGROUND

The present invention relates to a packaging for a medical device, wherein the medical device is particularly adapted for self-administering a medicament to a patient. In particular, the packaging is adapted to accommodate medical devices intended and designed for self-medication.

Medical devices and in particular drug delivery devices, such like pen-type injectors allow for a multiple dosing of a required dosage of a liquid medicament, such as insulin, heparin or the like. Devices of this kind further provide administering of the medicament to the patient, e.g. by way of injection. Generally, such devices have substantially the same purpose as a hypodermic syringe.

However, these and other medical devices require accurate handling, both in terms of setting and selecting a prescribed dose as well as in dispensing the dose to biological tissue. Depending on the respective medicament and its mandatory storage and/or preparation, the general functionality of such drug delivery devices may vary accordingly.

Additionally, elderly patients or those suffering a chronic disease may be additionally exposed to sequela or side effects, which may further deteriorate the patient's ability to handle the medical device in a correct way.

However, operating errors or misuse of the device may involve administering of incorrect doses of the medicament and may lead to sup-optimal medical treatment which may even involve severe health damages. Hence, there always exists a non-negligible risk of operating errors of the device.

Moreover, correct use of medical devices often builds on initial training given by a doctor or some other medical staff. Unfortunately, in practice, the training environment does not provide enough time to ensure, that the patient is sufficiently trained. With the manifold of products and medical devices prescribed by doctors, also from a point of view of the medical staff, it is almost impossible to know about the relevant and hot topics to point out for each device.

As an example, if a dialling operation is necessary to set a dose of a drug delivery device, some patients, for instance with dexterity problems may not be able to optimally use the device. Moreover, if for selecting or setting of a dose of the medicaments symbols, numbers or comparable tags play a particular role for a safe use of the device and the medicament, it should be ensured, that the patient understands the mode of operation of the device and its tags or symbols correctly.

The present invention therefore aims to provide improved patient safety and to facilitate training procedures required for correct use of medical devices, in particular of a drug delivery device, such like a pen-type injector.

### SUMMARY

The present invention suggests a packaging for a medical device that comprises a casing which is adapted to at least partially receive and/or to at least partially accommodate the medical device. While the medical device features at least one user-driven function or functionality, the casing comprises at least one functional element which is adapted to imitate the at least one function of the medical device. Hence, the functional element of the packaging is adapted to assimilate or to simulate the functionality of at least one user-driven or user-controlled function of the medical device. In this way, the user has to prove and to demonstrate of being physically and/or mentally able to handle the function of the medical device.

Preferably, the functional element of the packaging is almost identical to a corresponding functional element of the medical device. This way, when handed out to a user, e.g. in a training environment, the user can intuitively demonstrate of being generally able to make correct usage of the medical device and its function, e.g. by conducting a respective actuation of the functional element of the packaging.

This way, the functional packaging according to the present invention provides a threshold for patients having physical or mental limitations and which therefore should not make use of the device. If, for instance, the patient is unable to open the packaging, e.g. during a training routine, in which a doctor or other medical stuff is present, the patient should not be confronted with said medical device in a self-medication program, which the patient for instance could execute in a home environment.

In a preferred embodiment, the functional element of the packaging is operably engaged with a closure means of the casing. The closure means and the functional element only grant access to the medical device in response of a correct pre-defined handling of the functional element.

It is for instance beneficial when the functional element is adapted to impede opening or unsealing of the casing.

For this purpose, the functional element may be detachably connected to the closure means of the casing. This way, the closure means of the casing will only release or open if the functional element has been detached from the closure means in a well-defined way. Alternatively, the functional element may be modified regarding its position and/or orientation compared to the closure means or with respect to the casing, e.g. for releasing the closure means in order to provide access to the medical device disposed in the casing.

In a further embodiment, the closure means comprises at least a thread which is intersected by a protruding portion or pin of the functional element. Here, the protruding portion of the functional element of the packaging extends in a groove that traverses the thread at least in sections. As long as the protruding portion of the functional element is located within said groove, a threaded engagement of the closure means with e.g. a correspondingly threaded lid is interlocked. Consequently, as long as the functional element is located with its protruding portion inside the thread's groove, mutual rotation of the closure means for opening and/or closing the casing might by impeded.

In a further preferred aspect, the geometry and/or dimensions of the functional element correspond to the geometry and/or dimensions of the respective functional element of the medical device. If for instance the medical device, e.g. a pen-type injector comprises a dose button, which is either to be dialled, rotated or depressed by the user, the functional element of the packaging will preferably comprise a similar or even identical geometry and/or arrangement. Moreover, the functional element of the packaging should be detachably or reconfigurably arranged with the packaging in such a way, that the functional element of the packaging necessarily has to be actuated in the same or in a similar way than the respective functional element of the medical device prior to give access to the medical device.

In a further preferred embodiment, the packaging and/or the closure means comprise respective first and second components. Here, first and second casing- and/or first and second closure means-components comprise respective first and second functional elements that are moveably or rotatably disposed with respect to each other. A mutual position and/or orientation of first and second functional elements is indicative of the user-driven or user-induced function of the medical device. For instance, if the device handling requires reading or alignment of numbers or comparable tags disposed on the housing of the medical device, it is intended, that the first and second functional elements together with their associated first and second casing- or closure means-components simulate a respective device handling operation.

If, for instance a dose button of the medical device has to be rotated into a pre-defined orientation as indicated on the housing of the device, the first and second functional elements will comprise comparable or identical tags or indicators allowing to check, whether the patient is generally able to correctly handle the respective functionality of the device disposed in the packaging.

Consequently and according to a preferred embodiment, first and second components of the casing are translationally and/or rotatably mounted with respect to each other. Moreover, a pivot-mounted arrangement of first and second casing components relative to each other is also conceivable.

In a further preferred embodiment, the functional element comprises a visual, haptic and/or audible tag being indicative of the user-driven or user-induced functionality of the medical device. This way, the functional element may communicate with different human senses and may accordingly provide perceivable feedback to the user if displaced in a correct and/or incorrect way.

In a further aspect, the packing further comprises a drug delivery device being disposed therein, wherein in preferred embodiments, the packing is closed or sealed with a closure means being operably engaged with the functional element that reflects at least one user-driven function of the medical device.

It will be further apparent to those skilled in the pertinent art that various modifications and variations can be made to the present invention without departing from the spirit and scope of the invention. Further, it is to be noted, that any reference signs used in the appended claims are not to be construed as limiting the scope of the present invention.

### BRIEF DESCRIPTION OF THE DRAWINGS

In the following, various embodiments of the invention will be described in greater detail by making reference to the drawings, in which:

FIG. 1 schematically illustrates a sleeve-like packaging for a drug delivery device,

FIG. 2 illustrates in an enlarged view an upper section of the packaging according to the FIG. 1,

FIG. 3 exemplary illustrates an alternative embodiment of a multi-component housing in a first configuration and

FIG. 4 illustrates the packaging according to FIG. 3 in a second, released configuration.

### DETAILED DESCRIPTION

In FIG. 1, a substantially cylindrical sleeve-like housing 10 is illustrated accommodating a drug delivery device 12, which is for instance designed as pen-type injector. While the housing comprises a cupped and closed end at its lower portion, its opposite upper portion is provided with a circumferential thread 14 adapted to receive a correspondingly threaded lid, which is not explicitly illustrated in the Figures.

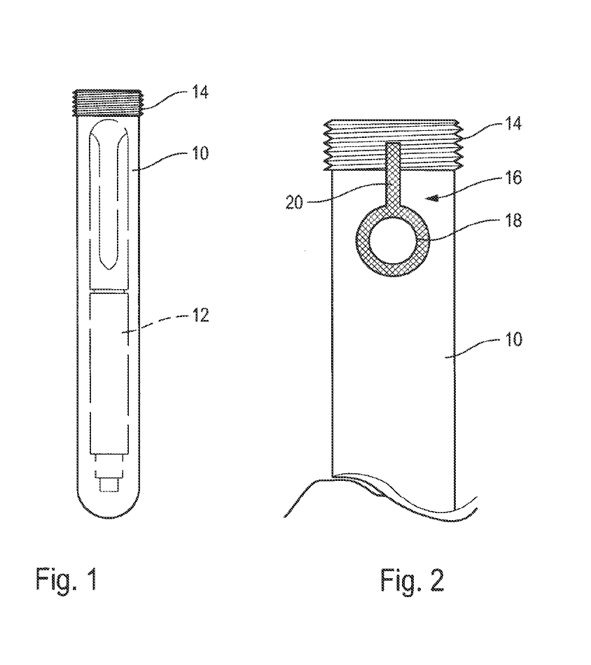

As illustrated in FIG. 2 in detail, the circumferential thread 14 at the opening of the housing 10 is at least partially intersected with an axially, hence upwardly extending protruding portion 20 of a functional element 16, which, for instance, is detachably connected to the thread 14. The functional element 16 further comprises a ring-like structure 18 serving as a gripping means to grip the functional element, e.g. for detaching the same from the thread 14.

Geometry and dimensions of the functional element 16, in particular of its ring-section 18 is designed such that it resembles and/or imitates a respective functional element of the drug delivery device 12, e.g. a dose button or a similar actuation means, that has to be activated, dialled, pushed or depressed by the user in order execute a dose-administering procedure.

By detaching the functional element 16 from the housing 10 and its threaded section 14, said threaded section 14 can for instance be used for screwing or unscrewing a respective lid thereto or therefrom. Consequently, prior to a use of the drug delivery device 12 contained in the housing 10, the patient has to prove of being able to grip and to detach the functional element 16 from the housing 10.

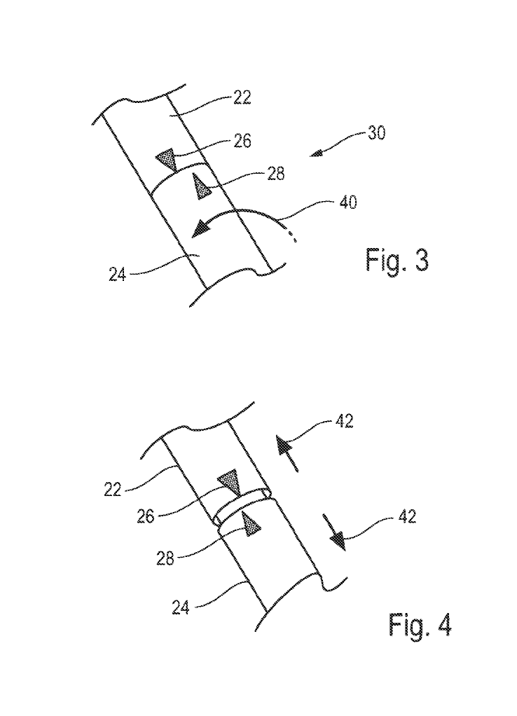

In an alternative embodiment as illustrated in FIGS. 3 and 4, a packaging 30 comprises two packaging sections or packaging components 22, 24, which in the configuration of FIG. 3 are rotatably mounted with respect to each other, as indicated by the arrow 40. On both sleeve-like packaging components 22, 24 there is disposed an alignment symbol or tag 26, 28, e.g. in form of a pointed triangle. These triangles 26, 28 for instance indicate, that for correct usage of the drug delivery device 12 the packaging components 22, 24 have to be rotated in such a way, that the pointed ends of the triangle 26, 28 are aligned in axial direction of the cylinder-like sleeves 22, 24.

Upon reaching a mutually aligned configuration of the functional elements 26, 28, a closure means may release and may allow, that the sleeve-like packaging components 22, 24 can be displaced in axial direction with respect to each other as indicated by the oppositely directed arrows 42, 44 in FIG. 4. Consequently, in this embodiment, the functional elements 26, 28 indicate on how to release a closure means of the packaging 10.

1-10. (canceled)

11. Packaging for a medical device comprising a casing adapted to at least partially receive and/or to accommodate the medical device featuring at least one user-driven function, wherein the casing comprises at least one functional element adapted to simulate the at least one function of the medical device, wherein the user driven function element of the medical device is either to be dialled, rotated or depressed and the functional element comprises a similar or identical geometry and/or arrangement.

12. Packaging according to claim 11, wherein the functional element is operably engaged with a closure means of the casing, granting access to the medical device only in response of a correct pre-defined handling of the functional element.

13. Packaging according to claim 11, wherein the functional element is adapted to impede an opening of the casing.

14. Packaging according to claim 13, wherein the functional element is detachably connected to the closure means of the casing.

15. Packaging according to claim 14, wherein the closure means comprises a thread intersected by a protruding portion of the functional element, wherein the protruding portion extends in a groove traversing the thread at least in sections.

16. Packaging according to claim 11, wherein the geometry and/or dimensions of the functional element correspond to the geometry and/or dimensions of a respective functional element of the medical device.

17. Packaging according to claim 11, wherein a first and a second component of the casing and/or a first and second component of the closure means comprise a respective first and second functional element, wherein the mutual position and/or orientation of first and second functional elements is indicative of the at least one function of the medical device.

18. Packaging according to claim 16, wherein first and second component of the casing are translationally and/or rotatably mounted with respect to each other.

19. Packaging according to claim 11, wherein the functional element comprises a visual, haptic and/or audible tag being indicative of the function of the medical device.

20. Packaging according to claim 11, further comprising a drug-delivery device disposed therein.
